(19) United States
(12) Patent Application Publication
(10) Pub. No.: US 2026/0317454 A1
(43) Pub. Date: Oct. 15, 2026

(54) PROCESS FOR THE POLYMERIZATION OF OLEFINS

(71) Applicant: Basell Poliolefine Italia S.r.l., Milano (IT)

(72) Inventors: Mara Destro, Ferrara (IT); Diego Brita, Ferrara (IT); Fabrizio Piemontesi, Ferrara (IT); Fabio Testoni, Ferrara (IT); Stefano Sessa, Ferrara (IT); Lelio Basile, Ferrara (IT); Alberto Nardin, Ferrara (IT); Tiziana Caputo, Ferrara (IT)

(73) Assignee: Basell Poliolefine Italia S.r.l., Milano (IT)

(21) Appl. No.: 19/486,287

(22) PCT Filed: May 31, 2024
(86) PCT No.: PCT/EP2024/065013

§ 371 Date: Nov. 20, 2025

(30) Foreign Application Priority Data
Jun. 1, 2023 (EP) 23176662.7

(51) Int. Cl. C08F 2/34; C08F 2/01; C08F 2/14; C08F 4/642; C08F 4/646; C08F 4/649; C08F 210/06; C08K 5/103

(52) U.S. Cl. CPC C08F 2/34; C08F 2/01; C08F 2/14; C08F 4/6421; C08F 210/06; C08K 5/103; C08F 4/6425; C08F 4/6426; C08F 4/6465; C08F 4/6494

(57) ABSTRACT

A process for the homopolymerization or copolymerization of propylene, carried out in the presence of (i) a Ziegler-Natta catalyst made from or containing Mg, Ti and an internal donor, (ii) an aluminum alkyl cocatalyst, optionally (iii) an external donor and (iv) at least 40 ppm of a polymerization process aid (PPA) made from or containing glycerol mono esters of mono unsaturated C₁₆-C₁₈ monocarboxylic acids, based on the amount of polyolefin produced.

### FIELD OF THE DISCLOSURE

In general, the present disclosure relates to the field of chemistry. More specifically, the present disclosure relates to polymer chemistry. In particular, the present disclosure relates to a process for preparing polyolefins.

### BACKGROUND OF THE DISCLOSURE

Polymerization process aids (PPAs) are used in processes for the polymerization of olefins to reduce or eliminate wall sheeting and formation of polymer agglomerates in the polymerization reactor or in downstream equipment. In some instances, the downstream equipment includes degassing and recovery vessels. In the context of olefin polymerization and depending upon the specific functions, PPAs include antifouling agents, antistatic agents, activity inhibitors, productivity inhibitors or kinetic modifiers. In some instances, PPAs are made from or containing compounds having polar functional groups. In some instances, the polar functional groups are acid or ester groups, amine or amide groups or hydroxyl or ether groups. In some instances, PPAs are selected from the group consisting of polysulfone copolymers, polymeric polyamines, polyalcohols, hydroxyesters of polyalcohols, salts of alkylarylsulfonic acids, polysiloxanes, alkoxyamines and polyglycol ethers.

It is believed that depending on the molecular structure, reaction conditions and reactor type, the effectiveness of PPAs changes in some instances. In some instances, the type of polyolefin plays a role. In some instances, propylene/ethylene rubbery copolymers tend to adhere to reactor walls and create fouling.

### SUMMARY OF THE DISCLOSURE

In a general embodiment, the present disclosure provides a process for the homopolymerization or copolymerization of propylene, carried out in the presence of (i) a Ziegler-Natta catalyst made from or containing Mg, Ti and an internal donor, (ii) an aluminum alkyl cocatalyst, optionally (iii) an external donor, and (iv) at least 40 ppm of a polymerization process aid (PPA) made from or containing glycerol mono esters of mono unsaturated C₁₆-C₁₈ monocarboxylic acids, based on the amount of polyolefin produced.

### BRIEF DESCRIPTION OF THE DRAWINGS

FIG. 1 shows a schematic of a gas phase polymerization reactor having two interconnected polymerization zones.

FIG. 2 shows absolute average static charge with standard deviation dotted line for the preparation of a propylene-ethylene copolymer.

### DETAILED DESCRIPTION OF THE DISCLOSURE

In some embodiments, the PPA is made from or containing glycerol monoesters of oleic acid, palmitoleic acid, or both.

In some embodiments, the PPA is made from or containing mono or diglycerol monooleate, mono or diglycerol mono ester of palmitoleic acid, or a combination thereof.

In some embodiments, the PPA is made from or containing (a) more than 50% wt, alternatively more than 55% wt, alternatively in the range of 60-90% wt, of glycerol monoesters of oleic acid, palmitoleic acid, or both, and (b) mono, diglycerol, or both esters with fatty acids, with respect to the total amount of mono and/or diglycerol esters with fatty acids.

In some embodiments, PPA is obtained by extraction from, treatment of, or both of natural sources. In some embodiments, the process for obtaining the PPA includes enzymatic glycerolysis. In some embodiments, the PPAs are commercially available in pure form or mixtures. In some embodiments, these compounds are produced by the esterification reaction of oleic acid and glycerol in the presence of catalysts. In some embodiments, the catalyst is H-ZSM-5 zeolite catalyst. In some embodiments, the process is as described in Esterification of glycerol monooleate from glycerol and oleic acid using microwave heating, AIP Conf. Proc. 2667, 080003 (2023).

In some embodiments, PPAs are used as such or with the aid of a dispersing medium. In some embodiments, the dispersing medium is selected from liquid non-aqueous solvents, alternatively from liquid hydrocarbons.

In some embodiments, the PPA is liquid at room temperature.

In some embodiments, the amount of PPA introduced into the polymerization reactor is from 50 to 2000 ppm per weight, alternatively from 70 to 1500 ppm per weight, alternatively from 100 to 1000 ppm per weight, referring to the weight of the prepared polyolefin.

In some embodiments, PPA is fed to the polymerization reactor in a flow of saturated or unsaturated hydrocarbons, having from 2 to 6 carbon atoms. In some embodiments, the hydrocarbon is a monomer or an alkane. In some embodiments, the monomer is propylene. In some embodiments, the alkane is propane. In some embodiments, the monomer and the alkane are in liquid or gas form. In some embodiments, the PPA is diluted and homogenized with a solvent at short distance from the injection point by mixing/homogenizing/dispersing systems, thereby increasing the volume and rendering the injection smoother and more reliable. In some embodiments, the mixing/homogenizing/dispersing systems are static mixers.

In some embodiments, the PPA is introduced into the reactor. In some embodiments, the PPA is fed directly into the reactor, into a line leading to the reactor, into a line exiting the reactor, or a combination thereof. In some embodiments, the PPA is fed:
upstream or into a catalyst precontacting vessel, that is, a vessel in which the catalyst components are brought into contact with each other;
upstream or into a prepolymerization reactor;
at any other point upstream a polymerization reactor;
in case of a cascade process with one or more liquid or gas phase reactors, at any point in-between two reactors;
distributed into a reactor or in a recirculation flow thereof;
in the polymer discharge out of a polymerization reactor; or
in the unreacted monomer separation and finishing sections downstream the polymerization reactor(s).
   In some embodiments, the PPA is distributed into a reactor or in a recirculation flow thereof, by feeding into the bed of a fluidized bed gas phase reactor, into the bed of a fast fluidization bed of a riser of a multizone circulating reactor, into a packed bed of a downcomer of a multizone circulating reactor, or a combination thereof.

In some embodiments, the present disclosure provides a process for the polymerization of olefins. In some embodiments, the olefins are 1-olefins, that is, hydrocarbons having terminal double bonds, without being restricted thereto. In some embodiments, the 1-olefins are selected from the group consisting of linear or branched 1-alkenes having from 2 to 12 carbon atoms, conjugated and non-conjugated dienes, and vinyl-aromatic compounds. In some embodiments, the linear 1-alkenes have from 2 to 10 carbon atoms. In some embodiments, the linear 1-alkenes are selected from the group consisting of ethylene, propylene, 1-butene, 1-pentene, 1-hexene, 1-heptene, 1-octene, and 1-decene. In some embodiments, the branched 1-alkenes have from 2 to 10 carbon atoms. In some embodiments, the branched 1-alkene is 4-methyl-1-pentene. In some embodiments, the dienes are selected from the group consisting of 1,3-butadiene, 1,4-hexadiene, and 1,7-octadiene. In some embodiments, the vinyl-aromatic compounds are styrene or substituted styrene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, 5-ethylidene-2-norbornene, norbornadiene, and ethylnorbornadiene. In some embodiments, mixtures of two or more olefins are polymerized.

In some embodiments, the process is for the homopolymerization or copolymerization of ethylene or for the homopolymerization or copolymerization of propylene. In some embodiments, the process is for the homopolymerization, copolymerization, or both of propylene.

In some embodiments, comonomers for use in ethylene polymerization are 1-alkenes having from 3 to 8 carbon atoms. In some embodiments, the 1-alkenes are selected from the group consisting of 1-butene, 1-pentene, 1-hexene and 1-octene. In some embodiments, the 1-alkenes are in amount of up to 20 wt. %, alternatively from 0.01 wt. % to 15 wt. %, alternatively from 0.05 wt. % to 12 wt. %, based on the total weight of the final polymer. In some embodiments, comonomers for use in propylene polymerization are ethylene, 1-butene, and 1-hexene. In some embodiments, the comonomers are in amount of up to 40 wt. %, alternatively from 0.5 wt. % to 35 wt. %, based on the total weight of the final polymer.

In some embodiments, the propylene/ethylene copolymer is made from or containing from 15 to 80% of ethylene, alternatively from 20 to 70% wt, based on the total weight of the copolymer.

In some embodiments, the present disclosure provides a process for preparing various types of olefin polymers. In some embodiments, the prepared olefin polymers are broad molecular weight olefin polymers. In some embodiments, the prepared olefin polymers are multimodal olefin polymers. As used herein, the term “multimodal” refers to the modality of the molecular weight distribution and includes bimodal. In some embodiments, the polymers are obtained from polymerizing olefins in a cascade of two or more polymerization reactors or in different zones of a multizone reactor under different reaction conditions. The “modality” indicates how many different polymerization conditions were utilized to prepare the polyolefin, independently whether this modality of the molecular weight distribution is recognizable as separated maxima in a gel permeation chromatography (GPC) curve. In some embodiments, the olefin polymer has a comonomer distribution.

In some embodiments, the polymerization of olefins is carried out using titanium-based Ziegler-Natta-catalysts.

In some embodiments, the Ziegler-Natta catalysts are made from or containing:
(i) a solid catalyst component made from or containing Mg, Ti, a halogen and optionally an electron donor compound (internal donor),
(ii) an alkylaluminum compound, and
(iii) optionally, an electron-donor compound (external donor).

In some embodiments, the solid catalyst component (i) is prepared by one or more steps (a) carried out at a temperature ranging from 0 to 150° C., wherein a Mg based compound of formula (MgClₘX₂₋ₘ)·nLB, where m ranges from 0 to 2, n ranges from 0 to 6, X is, independently, halogen, R¹, OR¹, —OCOR¹ or O—C(O)—OR¹ group, wherein R¹ is a C₁-C₂₀ hydrocarbon group, and LB is a Lewis base, is reacted with a liquid medium made from or containing a Ti compound, having at least a Ti—Cl bond, in an amount such that the Ti/Mg molar ratio is greater than 3.

In some embodiments, the liquid medium is made from or containing a titanium compound of formula Ti(OR¹)_{q-y}Cl_{y}, where q is the valence of titanium, y is a number between 1 and q and R¹ is a C₁-C₂₀ hydrocarbon group.

In some embodiments, the titanium compounds are titanium polyhalogenated compounds. In some embodiments, the titanium polyhalogenated compounds are titanium tetrahalides or halogenalcoholates. In some embodiments, the titanium compounds are selected from the group consisting of TiCl₄ and Ti(OEt)Cl₃.

In some embodiments, the liquid medium is made from or containing the Ti compound is a mixture of the Ti compound in another liquid diluent. In some embodiments, the diluents are hydrocarbons, optionally chlorinated, that are liquid at room temperature. In some embodiments, the liquid medium consists of the liquid titanium compound.

In some embodiments, the magnesium-based compound used as a starting compound in the first of the one or more steps (a) is selected among adducts of formula MgCl₂·nR¹OH, where n is a number between 0.1 and 6, and R¹ is a hydrocarbon radical having 1-18 carbon atoms. In some embodiments, n ranges from 1 to 5, alternatively from 1.5 to 4.5.

In some embodiments, the adduct is prepared by mixing alcohol and magnesium chloride, operating under stirring conditions at the melting temperature of the adduct (100-130° C.). Then, the adduct is mixed with an inert hydrocarbon immiscible with the adduct, thereby creating an emulsion which is quickly quenched causing the solidification of the adduct in the form of spherical particles. In some embodiments, the spherical adducts are prepared as described in U.S. Pat. Nos. 4,399,054 and 4,469,648.

In some embodiments, the spherulization occurs by a spray cooling method as described in U.S. Pat. Nos. 5,100,849 and 4,829,034. In some embodiments, the adducts, having a specified final alcohol content, are obtained by directly using the selected amount of alcohol during the adduct preparation.

In some embodiments, the adduct is directly reacted with the Ti compound or subjected to thermal controlled dealcoholation (80-130° C.), thereby obtaining an adduct wherein the number of moles of alcohol is lowered and the porosity increased. In some embodiments, the dealcoholation is carried out, thereby bringing the number of moles of alcohol per mole of Mg to less than 3, alternatively between 0.1 and 2.5.

In some embodiments, the reaction between the Mg-based compound and the Ti compound is carried out by suspending the Mg-based compound in large excess of cold TiCl₄. In some embodiments, the Mg-based compound is the MgCl₂-alcohol adduct. In some embodiments, the temperature of the cold TiCl₄ is 0° C. In some embodiments, the mixture is heated up to a temperature ranging from 60-140° C. and kept at this temperature for 0.1-4 hours, alternatively 0.5-2 hours. After that time, stirring is discontinued. After the solid particles settle, the liquid phase is removed.

In some embodiments, this reaction step (a) is carried out one or more times under identical or different conditions. In some embodiments, the temperature and duration of treatment are changed. In some embodiments, the number of steps (a) is between 1 and 3.

In some embodiments, the electron donor compound is added during one or more of the reaction steps (a) between the Mg-based compound and the liquid Ti compound.

In some embodiments, the electron donor compound is added at least during the first step (a) of reaction between the Mg-based compound and the Ti compound. In some embodiments, the addition of the electron donor compound is repeated one or two additional times.

In some embodiments, the electron donor compound is added as a fresh reactant to the solid intermediate catalyst component obtained by the reaction between the adduct and the Ti compound. In some embodiments, the electron donor compound is added as described in Patent Cooperation Treaty Publication No. WO2004/106388.

In some embodiments, the reaction step (a) is carried out by a continuous feeding of liquid Ti compound in an apparatus as described in Patent Cooperation Treaty Publication No. WO02/48208. In some embodiments, the liquid Ti compound is TiCl₄. In some embodiments, the Mg-based compound is fed batchwise while a continuous stream of liquid Ti compound with the specified temperature profile is fed and a liquid phase containing dissolved reaction product is continuously withdrawn. In some embodiments, the electron donor is added during the feeding of the Ti compound.

In some embodiments, the particles of solid catalyst component have substantially spherical morphology and average diameter ranging between 5 and 150 μm, alternatively from 20 to 100 μm, alternatively from 30 to 90 μm. In some embodiments, the polymerization process is carried out in gas-phase. As used herein, the term “particles having substantially spherical morphology” indicates that the particles have the ratio between the greater axis and the smaller axis is equal to or lower than 1.5, alternatively lower than 1.3.

In some embodiments, the amount of Mg ranges from 8 to 30% wt, alternatively from 10 to 25% wt, with respect to the total weight of solid catalyst component.

In some embodiments, the amount of Ti ranges from 0.5 to 5% wt, alternatively from 0.7 to 3% wt, with respect to the total weight of solid catalyst component.

In some embodiments, the internal electron donor is selected from the group consisting of ethers, amines, silanes, carbamates, ketones, esters of aliphatic acids, alkyl and aryl esters of optionally substituted aromatic polycarboxylic acids, diol derivatives, or mixtures thereof. In some embodiments, the diol derivatives are selected from the group consisting of monoesters monocarbamates and monoesters monocarbonates.

In some embodiments, the alkyl and aryl esters of optionally substituted aromatic polycarboxylic acids are the esters of phthalic acids. In some embodiments, the esters of aliphatic acids are selected from the esters of malonic, glutaric, maleic and succinic acids. In some embodiments, the esters are selected from the group consisting of n-butylphthalate, di-isobutylphthalate, and di-n-octylphthalate.

In some embodiments, the internal donors are selected from the group consisting of 1,3 diethers of the formula (I):

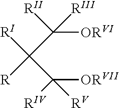

wherein R, R^{I}, R^{II}, R^{III}, R^{IV} and R^{V} are equal to or different from each other, and are hydrogen or hydrocarbon radicals having from 1 to 18 carbon atoms; and R^{VI} and R^{VII} are equal to or different from each other, and have the same meaning of R-R^{V} except that R^{VI} and R^{VII} cannot be hydrogen. In some embodiments, one or more of the R-R^{VII} groups are linked to form a cycle. In some embodiments, the 1,3-diethers have R^{VI} and R^{VII} selected from C₁-C₄ alkyl radicals.

In some embodiments, mixtures of the donors are used. In some embodiments, the mixtures are made from or containing esters of succinic acids and 1,3 diethers as described in Patent Cooperation Treaty Publication No. WO2011/061134.

It is believed that to increase the capability of the catalyst to distribute an olefin co-monomer within a polymer chain, the electron donor is selected from the group consisting of monofunctional donors. In some embodiments, the monofunctional donors are selected from the group consisting of ethers and C₁-C₄ alkyl esters of aliphatic mono carboxylic acids. In some embodiments, the resulting polymers are ethylene/α-olefin copolymers. In some embodiments, the ethers are C₂-C₂₀ aliphatic ethers, alternatively cyclic ethers. In some embodiments, the cyclic ethers have 3-5 carbon atoms. In some embodiments, the cyclic ethers are selected from the group consisting of tetrahydrofuran, methyl tetrahydrofuran, and dioxane. In some embodiments, the esters are selected from the group consisting of ethylacetate and methyl formiate. In some embodiments, the electron donor is selected from the group consisting of tetrahydrofuran and ethylacetate.

In some embodiments, the final amount of electron donor compound in the solid catalyst component ranges from 0.5 to 40 wt % by weight, alternatively from 1 to 35 wt %, with respect to the total weight of the solid catalyst component.

In some embodiments, the solid catalyst component shows a surface area (by B.E.T. method) between 20 and 500 m²/g, alternatively between 50 and 400 m²/g, and a total porosity (by B.E.T. method) greater than 0.2 cm³/g, alternatively between 0.3 and 0.6 cm³/g. In some embodiments, the porosity (Hg method) due to pores with radius up to 10.000 Å, ranges from 0.3 to 1.5 cm³/g, alternatively from 0.45 to 1.0 cm³/g.

In some embodiments, the solid catalyst component is converted into catalyst for the polymerization of olefins by reacting the solid catalyst component with alkylaluminum compounds (ii).

In some embodiments, the alkylaluminum compound (ii) is a trialkyl aluminum compound. In some embodiments, the trialkyl aluminum compound is selected from the group consisting of triethylaluminum, triisobutylaluminum, tri-n-butylaluminum, tri-n-hexylaluminum, and tri-n-octylaluminum. In some embodiments, the trialkyl aluminum compound is selected from the group consisting of alkylaluminum halides, alkylaluminum hydrides, alkylaluminum sesquichlorides, and mixtures thereof. In some embodiments, the alkylaluminum sesquichlorides are selected from the group consisting of AlEt₂Cl and Al₂Et₃Cl₃.

In some embodiments, the Al/Ti molar ratio is such that there is an excess of Al. In some embodiments, the Al/Ti molar ratio ranges between 50:1 and 2000:1, alternatively between 50:1 and 500:1.

In some embodiments, an external electron-donor compound (iii) is used. In some embodiments, the external electron-donor compound is selected from the group consisting of silicon compounds, ethers, esters, amines, heterocyclic compounds, and ketones. In some embodiments, the heterocyclic compound is 2,2,6,6-tetramethylpiperidine. In some embodiments, the external donor compounds are silicon compounds of formula (R₆)ₐ(R₇)_{b}Si(OR₈)_{c}, where a and b are integers from 0 to 2, c is an integer from 1 to 4 and the sum of (a+b+c) is 4; R₆, R₇, and R₈, are alkyl, cycloalkyl or aryl radicals with 1-18 carbon atoms optionally containing heteroatoms. In some embodiments, the external electron-donor compounds are the silicon compounds wherein a is 1, b is 1, and c is 2, at least one of R₆ and R₇ is selected from branched alkyl, cycloalkyl or aryl groups with 3-10 carbon atoms optionally containing heteroatoms, and R₈ is a C₁-C₁₀ alkyl group. In some embodiments, R₈ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl)t-butyldimethoxysilane, (2-ethylpiperidinyl)thexyldimethoxysilane, (3,3,3-trifluoro-n-propyl)(2-ethylpiperidinyl)dimethoxysilane, and methyl(3,3,3-trifluoro-n-propyl)dimethoxysilane. In some embodiments, the external electron-donor compounds are the silicon compounds wherein a is 0 and c is 3, R₇ is a branched alkyl or cycloalkyl group, optionally containing heteroatoms, and R₈ is methyl. In some embodiments, the silicon compounds are selected from the group consisting of cyclohexyltrimethoxysilane, t-butyltrimethoxysilane and thexyltrimethoxysilane.

In some embodiments, the external electron donor compound is used in an amount such that the molar ratio alkylaluminum compound to the external electron donor compound is from 0.1:1 to 500:1, alternatively from 1:1 to 300:1, alternatively from 3:1 to 100:1.

In some embodiments, the molar ratio of PPA to alkylaluminum compound (ii) introduced into the polymerization reactor is from 0.05 to 3, alternatively from 0.1 to 2, alternatively from 0.5 to 1.

In some embodiments, the catalyst components (i)-(iii) are contacted with a liquid inert hydrocarbon solvent at a temperature below about 60° C., alternatively from about 0 to 30° C., for a time period of from about six seconds to 60 minutes. In some embodiments, the liquid inert hydrocarbon solvent is propane, n-hexane or n-heptane.

In some embodiments, the catalyst components (i), (ii) and optionally (iii) are fed to a pre-contacting vessel, in amounts such that the weight ratio (ii/(i) is in the range of 0.1-10. In some embodiments, the compound (iii) is present and the weight ratio (ii)/(iii) is as defined above. In some embodiments, the components are pre-contacted at a temperature of from 10 to 20° C. for 1-30 minutes. In some embodiments, the precontact vessel is a stirred tank or a loop reactor.

In some embodiments, the pre-contacted catalyst is then fed to the pre-polymerization reactor where step (b) takes place. In some embodiments, the pre-polymerization step is carried out in a first reactor selected from a loop reactor or a continuously stirred tank reactor. In some embodiments, the pre-polymerization is carried out in gas-phase or in liquid-phase. In some embodiments, the prepolymerization is carried out in liquid-phase. In some embodiments, the liquid medium is made from or containing liquid alpha-olefin monomer(s), optionally with the addition of an inert hydrocarbon solvent. In some embodiments, the hydrocarbon solvent is aromatic or aliphatic. In some embodiments, the aromatic solvent is toluene. In some embodiments, the aliphatic solvent is selected from the group consisting of propane, hexane, heptane, isobutane, cyclohexane and 2,2,4-trimethylpentane. In some embodiments, the amount of hydrocarbon solvent is lower than 40% by weight, alternatively lower than 20% by weight, with respect to the total amount of alpha-olefins. In some embodiments, step (b) is carried out in the absence of inert hydrocarbon solvents.

In some embodiments, the average residence time in this reactor ranges from 2 to 40 minutes, alternatively from 10 to 25 minutes. In some embodiments, the temperature is between 10° C. and 50° C., alternatively between 20° C. and 40° C. In some embodiments, these conditions yield a pre-polymerization degree ranging from 60 to 800 g, alternatively from 150 to 500 g, per gram of solid catalyst component. In some embodiments, the pre-polymerization step yields a low concentration of solid in the slurry, alternatively a concentration of solid in the range from 50 g to 300 g of solid per liter of slurry.

In some embodiments, the process is carried out in a polymerization plant including a liquid-phase polymerization reactor, a gas-phase polymerization reactor, or both. In some embodiments, the liquid-phase reactors are selected from the group consisting of loop reactors and continuously stirred tank reactors (CSTR). In some embodiments, the gas-phase reactors are selected from the group consisting of fluidized bed reactors, stirred bed reactors and reactors having two interconnected polymerization zones as described in European Patent Application No. EP 0782587 and EP 1012195. In some embodiments, the process is carried out in two or more cascade reactors, giving rise to a sequential multistage polymerization process. In some embodiments, a fluidized bed reactor is used to prepare a first polymer component, which is successively fed to a gas-phase reactor, having two interconnected polymerization zones, to prepare a second polymer component and a third polymer component. In some embodiments, a first fluidized bed reactor is used to prepare a first polymer component, which is successively fed to a second fluidized bed reactor to prepare a second polymer component and then to a third fluidized bed reactor to prepare a third polymer component. In some embodiments, an olefin polymer with a multi-modal molecular weight distribution is obtained. In some embodiments, an olefin copolymer made from or containing two or more components, having a different comonomer content, is prepared.

In some embodiments, the polymerization process is carried out as gas-phase polymerization, that is, by a process in which the solid polymers are obtained from a gas-phase of the monomer or the monomers. In some embodiments, the gas-phase polymerizations are carried out at pressures of from 0.1 to 20 MPa, alternatively from 0.5 to 10 MPa, alternatively from 1.0 to 5 MPa, and polymerization temperatures from 40 to 150° C., alternatively from 65 to 125° C.

In some embodiments, gas-phase polymerization reactors are selected from the group consisting of horizontally or vertically stirred reactors, fluidized bed gas-phase reactors, and multizone circulating reactors.

Fluidized-bed polymerization reactors are reactors in which the polymerization takes place in a bed of polymer particles, which is maintained in a fluidized state by feeding in gas at the lower end of a reactor and taking off the gas again at the reactor's upper end. In some embodiments, the gas is fed below a gas distribution grid, having the function of dispensing the gas flow. The reactor gas is then returned to the lower end of the reactor via a recycle line equipped with a compressor and a heat exchanger. In some embodiments, the circulated reactor gas is a mixture of the olefins to be polymerized, inert gases, and optionally a molecular weight regulator. In some embodiments, the inert gases are selected from the group consisting of nitrogen, lower alkanes, or both. In some embodiments, the lower alkanes are selected from the group consisting of ethane, propane, butane, pentane, and hexane. In some embodiments, the molecular weight regulator is hydrogen. In some embodiments, nitrogen or propane is used as inert gas, alternatively in combination with further lower alkanes. In some embodiments, the velocity of the reactor gas fluidizes the mixed bed of finely divided polymer present in the tube serving as polymerization zone and removes the heat of polymerization. In some embodiments, the polymerization is carried out in a condensed or super-condensed mode, wherein part of the circulating reaction gas is cooled to below the dew point and returned to the reactor separately as a liquid and a gas-phase or together as a two-phase mixture, thereby using the enthalpy of vaporization for cooling the reaction gas.

Multizone circulating reactors are gas-phase reactors in which two polymerization zones are linked to one another and the polymer is passed alternately a plurality of times through these two zones. In some embodiments, the reactors are as described in Patent Cooperation Treaty Publication Nos. WO97/04015 A1 and WO00/02929 A1 and have two interconnected polymerization zones, a riser, in which the growing polymer particles flow upward under fast fluidization or transport conditions and a downcomer, in which the growing polymer particles flow in a densified form under the action of gravity. The polymer particles, leaving the riser, enter the downcomer, and the polymer particles, leaving the downcomer, are reintroduced into the riser, thereby establishing a circulation of polymer between the two polymerization zones. The polymer is passed alternately a plurality of times through these two zones. In some embodiments, the two polymerization zones of one multizone circulating reactor are operated with different polymerization conditions by establishing different polymerization conditions in the riser and the downcomer. In some embodiments, the gas mixture, leaving the riser and entraining the polymer particles, is partially or totally prevented from entering the downcomer. In some embodiments, a barrier fluid is fed in form of a gas, a liquid mixture, or both into the downcomer, in the upper part thereof. In some embodiments, the barrier fluid has a composition different from the composition of the gas mixture present in the riser. In some embodiments, the amount of added barrier fluid is adjusted such that an upward flow of gas countercurrent to the flow of the polymer particles is generated, thereby acting as a barrier to the gas mixture entrained among the particles coming from the riser. In some embodiments, the countercurrent occurs at the top thereof. In some embodiments, two different gas composition zones occur in a multizone circulating reactor. In some embodiments, make-up monomers, comonomers, molecular weight regulator, inert fluids, or a combination thereof is introduced at a point of the downcomer, below the barrier feeding point. In some embodiments, the molecular weight regulator is hydrogen. In some embodiments, varying monomer, comonomer and hydrogen concentrations along the downcomer are used to differentiate the polymerization conditions.

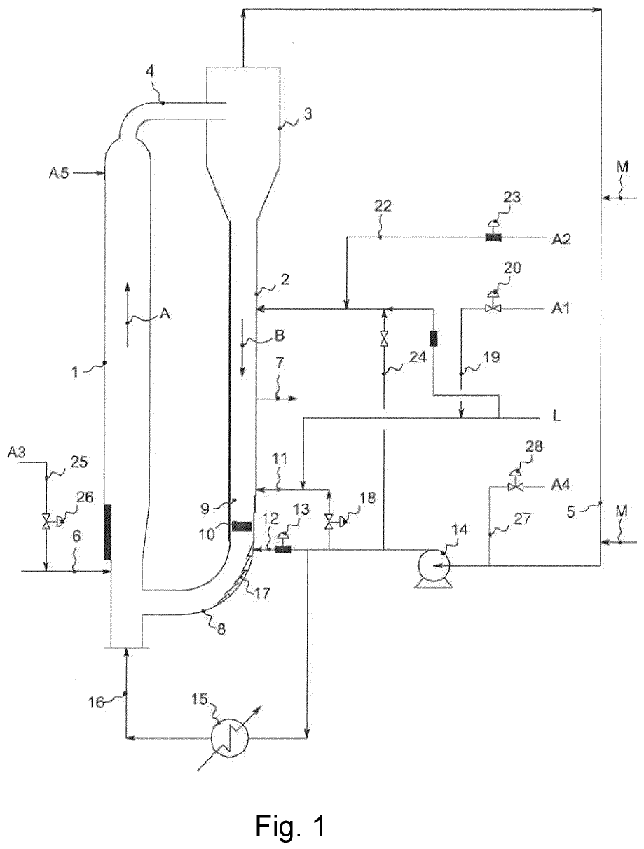

With reference to FIG. 1, a gas phase polymerization reactor having two interconnected polymerization zones (riser and downcomer) is shown.

In some embodiments, the polymerization reactor includes a first polymerization zone 1 (riser), wherein the polymer particles flow upward under fast fluidization conditions along the direction of the arrow A and a second polymerization zone 2 (downcomer), wherein the polymer particles flow downward under the action of gravity along the direction of the arrow B.

The upper portion of the riser 1 is connected to a solid/gas separator 3 by an interconnection section 4. The separator 3 removes a major part of the unreacted monomers from the polymer particles. The polymer withdrawn from the bottom of separator 3 enters the top portion of the downcomer 2. The separated unreacted monomers, optionally together with polymerization diluents, flow up to the top of separator 3 and are successively recycled to the bottom of the riser 1 via a recycle line 5. In some embodiments, the diluent is propane.

In some embodiments, a mixture made from or containing one or more olefin monomers, hydrogen as a molecular weight regulator, propane as a polymerization diluent, is fed to the polymerization reactor via one or more lines M, which are placed along the gas recycle line 5.

In some embodiments, the catalyst components, optionally after a pre-polymerization step, are continuously introduced into the riser 1 via line 6. In some embodiments, the produced polymer is discharged from the reactor via a line 7. In some embodiments, line 7 is placed on the lower portion of the downcomer 2, thereby and due to the packed flow of densified polymer, minimizing the quantity of gas entrained with the discharged polymer. In some embodiments and not shown herein, a control valve is inserted on the polymer discharge line 7, thereby providing for continuous control of the flow rate of polymer produced by the polymerization reactor. In some embodiments, additional polymer discharge lines with respect to line 7 are placed in the bottom part of the downcomer.

In some embodiments, the polymerization reactor further includes a transport section 8 connecting the bottom of downcomer 2 with the lower region of the riser 1. In some embodiments, the bottom of the downcomer 2 converges into a slight restriction 9. In some embodiments, a control valve 10 with an adjustable opening is placed within the restriction 9. In some embodiments, the flow rate Fp of polymer continuously circulated between the downcomer 2 and the riser 1 is adjusted by the level of opening of the control valve 10. In some embodiments, the control valve 10 is a mechanical valve. In some embodiments, the mechanical value is selected from the group consisting of a butterfly valve and a ball valve. In some embodiments, a stream of dosing gas is fed into the lower part of the downcomer 2 by a line 11 placed at a short distance above the restriction 9. In some embodiments, the dosing gas to be introduced through line 11 is taken from the recycle line 5. In some embodiments, the flow Fp of polymer particles circulated between downcomer 2 and riser 1 is adjusted by varying the opening of the control valve 10 at the bottom of the downcomer, by varying the flow rate of the dosing gas entering the downcomer via line 11, or both. In some embodiments, the flow rate of dosing gas is adjusted by a control valve 18, which is arranged on line 11.

The transport section 8 is designed as a bend descending from the bottom of downcomer 2 up to the lower region of the riser 1. In some embodiments, a carrier gas is introduced via line 12 at the inlet of the transport section 8. In some embodiments, the flow rate of carrier gas is adjusted by a control valve 13, which is arranged on line 12.

In some embodiments, the carrier gas is taken from the gas recycle line 5. In some embodiments, the gas recycle stream of line 5 is first subjected to compression by a compressor 14. A minor percentage of the recycle stream passes through line 12, thereby entering the transport section 8 and diluting the solid phase of polymer flowing through the transport section 8. The major part of the recycle stream, downstream the compressor 14, is subjected to cooling in a heat exchanger 15 and successively introduced via line 16 at the bottom of the riser 1 at a high velocity, thereby ensuring fast fluidization conditions in the polymer bed flowing along the riser 1.

In some embodiments, the carrier gas merges with the densified polymer coming from downcomer 2 at the inlet portion of transport section 8, after exiting the slits of the gas distribution grid 17. In some embodiments, the top end of the distribution grid 17 coincides with the inlet of the transport section 8. In some embodiments, the distribution grid 17 extends along the bending of the transport section 8 for an angle α=60°. The gas distribution grid 17 is formed by a plurality of trays fixed to the transport section 8 which form slits in the overlapping area of adjacent trays. In some embodiments, the gas distribution grid 17 is as described in Patent Cooperation Treaty Publication No. WO 2012/031986.

In some embodiments, a flow rate of compound (iv) is metered into the reactor at the bottom of the riser, at a point in the riser 1, or both. In some embodiments, a flow rate of compound (iv) is metered into the reactor at the top of the riser (flow rate A5).

In some embodiments, an additional feeding point is at flow rate A3, via line 25 and metered by valve 26 into catalyst feed line 6. In some embodiments, an additional feeding point is into the main gas recycle line 5 (flow rate A4, line 27 metered by valve 28).

In some embodiments, the compound (iv) is alternatively or additionally metered to positions along the height of the downcomer via nozzles as described in Patent Cooperation Treaty Publication No. WO 2011/029735. In some embodiments, the compound (iv) flow rate A2 in line 22 is metered by one or more valves 23 and then pre-dispersed in the liquid monomer L or in a fraction of recycle gas taken from recycle line 5 via line 24.

In some embodiments and depending on the olefin homopolymer or copolymer to be produced, the polymerization reactor is operated by adjusting the polymerization conditions and the monomers concentration in the riser and in the downcomer. In some embodiments, the process produces a wide variety of bimodal homopolymers and random copolymers. In some embodiments, the gas mixture entraining the polymer particles and coming from the riser is partially or totally prevented from entering the downcomer, thereby polymerizing two different monomers compositions in the riser and the downcomer. In some embodiments, a gaseous barrier stream, a liquid barrier stream, or both are fed through a line placed in the upper portion of the downcomer. In some embodiments, the barrier stream has a composition different from the gas composition present inside the riser. In some embodiments, the flow rate of the barrier stream is adjusted, thereby generating an upward flow of gas counter-current to the flow of the polymer particles and acting as a barrier to the gas mixture coming from the riser. In some embodiments, the counter-current is at the top of the downcomer. In some embodiments, the barrier effect at the top of the downcomer occurs as described in European Patent Application No. EP 1012195 A1.

In some embodiments, the different or identical polymerization processes are connected in series, thereby forming a polymerization cascade. In some embodiments, a parallel arrangement of reactors of two or more different or identical processes is used.

In some embodiments, the gas-phase polymerization processes are carried out in the presence of an alkane having from 3 to 5 carbon atoms as a polymerization diluent. In some embodiments, the diluent is propane.

In some embodiments, the process is used in a multizone circulating reactor for producing polymer particles having a MFR_{2.16} at a temperature of 190° C. under a load of 2.16 kg of less than 60 g/10 min.

In some embodiments, the process is a cascade process including two or more fluidized-bed gas-phase reactors, compound (iv) is added into the bed of each reactor, to the polymer discharge downstream each reactor, before the first reactor, or a combination thereof.

In some embodiments, the compound (iv) is antistatic composition, thereby reducing the tendency to form polymer deposits on the rector wall, that is, reactor fouling, lumps and fines.

### EXAMPLES

The following examples are given to be illustrative without limiting the scope of this disclosure in any manner whatsoever.

### Test Methods

### Melt Flow Rate (MFR “L”)

Determined according to ISO 1133 (230° C., 2.16 Kg).

### Ethylene Content in Copolymers

### 13C NMR of Propylene/Ethylene Copolymers

13C NMR spectra were acquired on a Bruker AV-600 spectrometer equipped with cryoprobe, operating at 160.91 MHz in the Fourier transform mode at 120° C.

The peak of the Sββ carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules 1982, 15, 4, 1150-1152) using the following equations:

PPP=100Tββ/S

PPE=100Tβδ/S

EPE=100Tδδ/S

PEP=100Sββ/S

PEE=100Sβδ/S

EEE=100(0.25Sγδ+0.5Sδδ)/S

S=Tββ+Tβδ+Tδδ+Sββ+Sβδ+0.25Sγδ+0.5Sδδ

The molar percentage of ethylene content was evaluated using the following equation:

E % mol=100*[PEP+PEE+EEE]

The weight percentage of ethylene content was evaluated using the following equation:

$$E \% wt . = \frac{100 * E \% mol * {MW}_{E}}{E \% mol * {MW}_{E} + P \% mol * {MW}_{P}}$$

where P % mol is the molar percentage of propylene content, while MW_{E} and MW_{P} are the molecular weights of ethylene and propylene, respectively.

### Xylene Solubles (XS)

Determined as follows: 2.5 g of polymer and 250 ml of xylene were introduced in a glass flask equipped with a refrigerator and a magnetic stirrer. The temperature was raised in 30 minutes up to the boiling point of the solvent. The solution was then kept under reflux and stirring for further 30 minutes. The closed flask was then kept in thermostatic water bath at 25° C. for 30 minutes. The formed solid was filtered on quick filtering paper. 100 ml of the filtered liquid was poured in a pre-weighed aluminum container, which was heated on a heating plate under nitrogen flow, thereby removing the solvent by evaporation. The container was then kept in an oven at 80° C. under vacuum until constant weight was obtained. The weight percentage of polymer soluble in xylene at room temperature was then calculated.

### Samples for the Mechanical Tests

Samples have been obtained according to ISO 1873-2:2007.

Charpy impact test is determined according to ISO 179-1eA, and ISO 1873-2

Elongation at yield: measured according to ISO 527.

Elongation at break: measured according To ISO 527

Stress at break: measured according to ISO 527.

Tensile Modulus according to ISO 527-2,

### Melting Point and Crystallization Point

The melting point was measured using a Differential Scanning calorimetry (DSC) instrument according to ISO 11357-3, at scanning rate of 20 C/min both in cooling and heating, on a sample of weight between 5 and 7 mg., under inert N2 flow. Instrument calibration was made with Indium.

### Example 1

### Preparation of the Ziegler-Natta Solid Catalyst Component

An initial amount of microspheroidal MgCl₂·2.8C₂H₅OH adduct was prepared according to the method described in Example 2 of Patent Cooperation Treaty Publication No. WO98/44009, but operating on a larger scale. The adduct was then partially dealcoholated in a nitrogen flow until the alcohol content reached the value of 50% wt, based on the total weight of the adduct.

300 ml of TiCl₄ were introduced at room temperature under nitrogen atmosphere into a 500 ml round bottom flask, equipped with a mechanical stirrer, a cooler and a thermometer. After cooling to 0° C., while stirring, diisobutylphthalate (internal donor) and 9.0 g of the adduct were sequentially added into the flask. The amount of internal donor added was to meet a Mg/donor molar ratio of 8. The temperature was raised to 100° C. and maintained for 2 hours. Thereafter, stirring was stopped. The solid product was allowed to settle. The supernatant liquid was siphoned off at 100° C. After the supernatant was removed, additional fresh TiCl₄ was added to reach the initial liquid volume again. The mixture was then heated at 120° C. and kept at this temperature for 1 hour. Stirring was stopped again. The solid was allowed to settle. The supernatant liquid was siphoned off. The solid was washed with anhydrous hexane six times in temperature gradient down to 60° C. and one time at room temperature. The solid was then dried under vacuum and analyzed.

### Catalyst Activation and Prepolymerization

Before introducing the solid catalyst component into the polymerization reactors, the solid catalyst component was contacted with triethylaluminum (TEAL) and with dicyclopentyldimethoxysilane (donor D) under the conditions reported in Table 1.

The activated catalyst discharged from the activation vessel was continuously fed, together with liquid propylene, to a pre-polymerization loop reactor, operated at a temperature of 20° C. and a residence time of 7 minutes.

### Polymerization

### Procedure for Propylene-Ethylene Copolymerization

The propylene-ethylene copolymer of the example was prepared in a single gas-phase polymerization reactor having two interconnected polymerization zones, a riser and a downcomer. For measuring the static charges, the reactor was equipped with electrostatic probes, PI and P2, located in the riser and downcomer respectively. Triethylaluminum (TEAL) was used as co-catalyst and dicyclopentyldimethoxysilane as external donor, with the weight ratios indicated in Table 1 together with polymerization conditions. The characterization of the polymer produced is reported in Table 2.

As PPA compound (iv), 180 ppm (with respect to the amount of polymer produced) of a glycerol ester of fatty acids mixture, containing 72% wt of mono and diglycerol monooleate, were used in mixture with 60% wt of mineral oil. The mixture was diluted with iso-hexane and fed to the bottom of the riser and to the top of the riser, using a propylene carrier.

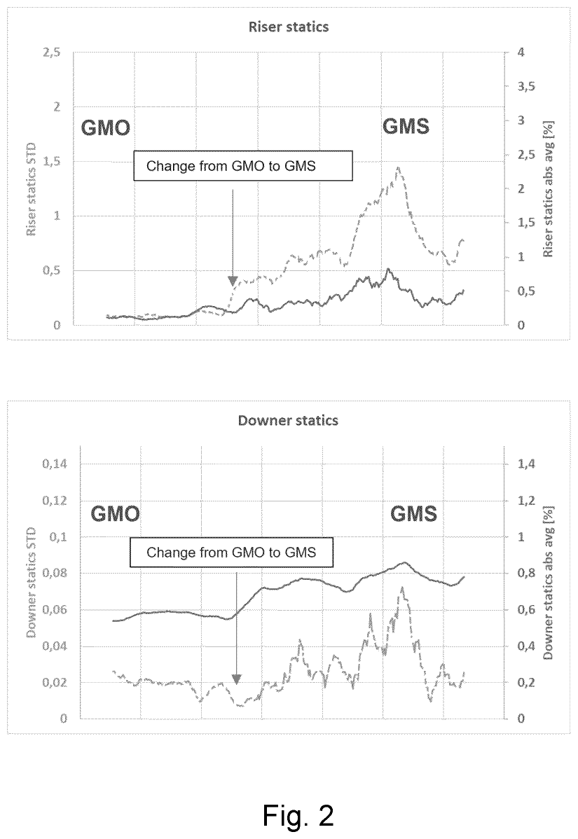

FIG. 2 shows the effect of compound (iv) on the preparation of the propylene-ethylene copolymer, wherein the solid line reflects the absolute average static charge and the dotted line reflects the standard deviation of the absolute average static charge.

### Example 2 (Comparative)

After running example 1 for 2 days, the feeding of PPA-1 was terminated and replaced by the feeding of the same quantity (180 ppm) of molten glycerol monostearate as PPA-2. The polymerization run was carried out for 5 days. Polymerization conditions and characterization are reported in Table 1 and Table 2.

TABLE 1

| Example | | 1 | Comp 2 |
|---|---|---|---|
| TEAL/external donor | wt/wt | 4 | 4 |
| TEAL/catalyst | wt/wt | 5 | 5 |
| Temperature | °C | 70 | 70 |
| Pressure | bar-g | 27 | 27 |
| C2/C2 + C3 − riser/downer | mol/mol | 0.027 | 0.027 |
| H₂/C₃ riser | mol/mol | 0.0867 | 0.0867 |
| Activity | Kg/gcat | 36 | 35 |

C2 = ethylene
C3 = propylene

TABLE 2

example

| Component A | | 1 | Comp. 2 |
|---|---|---|---|
| MFR | g/10′ | 29 | 37 |
| C2 | % | 2.4 | 3.0 |
| XS | % | 5.8 | 6.2 |
| XSIV | dl/g | 1.08 | 1.50 |
| Tensile Modulus | Mpa | 1290 | 1270 |
| Haze (on plaque | % | 8.9 | 10.1 |
| 1 mm) | | | |
| Stress at yield | Mpa | 31.0 | 31.5 |
| Elongation at break | % | 690 | 420 |
| D/B TT | °C | −29 | −37 |
| Tm | °C | 148.7 | 149.2 |
| Tc | °C | 117.8 | 118.4 |
| n-Hexane extractables | % | 3.9 | 3.7 |
| (on Film) | | | |

What is claimed is:

1. A process for the homopolymerization or copolymerization of propylene, carried out in the presence of (i) a Ziegler-Natta catalyst comprising Mg, Ti and an internal donor, (ii) an aluminum alkyl cocatalyst, optionally (iii) an external donor, and (iv) at least 40 ppm of a polymerization process aid (PPA) comprising glycerol mono esters of mono unsaturated C₁₆-C₁₈ monocarboxylic acids, based on the amount of polyolefin produced.

2. The process according to claim 1, wherein the process is carried out in gas-phase.

3. The process according to claim 1, wherein the homopolymerization, the copolymerization, or both of propylene is carried out.

4. The process according to claim 1, wherein the internal donor is selected from the group consisting of ethers, amines, silanes, carbamates, ketones, esters of aliphatic acids, alkyl and aryl esters of optionally substituted aromatic polycarboxylic acids, diol derivatives, or mixtures thereof.

5. The process according to claim 1, wherein an external electron-donor compound (iii) is present and selected from silicon compounds of formula (R₆)ₐ(R₇)_{b}Si(OR₈)_{c}, where a and b are integers from 0 to 2, c is an integer from 1 to 4 and the sum of (a+b+c) is 4; R₆, R₇, and R₈, are alkyl, cycloalkyl or aryl radicals with 1-18 carbon atoms optionally containing heteroatoms.

6. The process according to claim 1, wherein the PPA comprises glycerol monoesters of oleic acid, palmitoleic acid, or both.

7. The process according to claim 1, wherein the PPA comprises mono or diglycerol monooleate, mono or diglycerol mono ester of palmitoleic acid, or a combination thereof.

8. The process according to claim 1, wherein the PPA comprises (a) more than 50% wt of glycerol monoesters of oleic acid, palmitoleic acid, or both and (b) mono, diglycerol, or both esters with fatty acids, with respect to the total amount of mono and/or diglycerol esters with fatty acids.

9. The process according to claim 1, wherein the PPA is liquid at room temperature.

10. The process according to claim 1, wherein compound (iv) is dispersed in a medium selected from liquid non-aqueous solvents.

11. The process according to claim 1, wherein the PPA is introduced into the polymerization reactor in an amount ranging from 50 to 2000 ppm per weight, based on the weight of the prepared polyolefin.

12. The process according to claim 10, wherein the PPA is introduced into the polymerization reactor in an amount ranging from 70 to 1500 ppm per weight, based on the weight of the prepared polyolefin

13. The process according to claim 1, wherein the PPA is fed to the polymerization reactor in a flow of saturated or unsaturated hydrocarbons, having from 2 to 6 carbon atoms.

14. The process according to claim 1, wherein the PPA is fed directly into the reactor, into a line leading to the reactor, into a line exiting the reactor, or a combination thereof.

15. The process according to claim 1, wherein the PPA is fed upstream the polymerization reactor.
